(19) United States
(12) Patent Application Publication
(10) Pub. No.: US 2006/0083332 A1
(43) Pub. Date: Apr. 20, 2006

(54) Apparatus enabled for optimizing spectral efficiency of a wireless link

(75) Inventors: Wilhelmus Mathias Clemens Dolmans, Eindhoven (NL); Bertrand Jacques Leonard Vandewiele, Eindhoven (NL); Lukas Leyten, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics, N.V., Eindhoven (NL)

(21) Appl. No.: 10/540,385

(22) PCT Filed: Dec. 1, 2003
(86) PCT No.: PCT/IB03/05693

§ 371 Date: Jun. 22, 2005

(30) Foreign Application Priority Data
Dec. 30, 2002 (EP) 02080567.7

(51) Int. Cl. H04L 27/04

(52) U.S. Cl. 375/299

(57) ABSTRACT

An apparatus simultaneously transmits at least a first signal and a second signal. Each one of those signals comprises a data sequence and a training sequence. The apparatus is arranged to simultaneously transmit a training sequence of the first signal and a data sequence of the second signal for improving the spectral efficiency and thus the data throughput.

This invention relates to an apparatus for simultaneous transmission of at least a first signal and a second signal, each one of said signals comprising a data sequence and a training sequence. The invention further relates to a module for use in an apparatus and also to simultaneous signals for transmission by an apparatus.

An apparatus of the kind set forth in the opening paragraph is known from the 3^{rd} IEEE workshop on Wireless Local Area Networks, Sep. 27-28, 2001 Newton Mass. This workshop proposed a training period for a MIMO system having four antennas wherein during the training period, only one antenna at a time is activated, solely for the transmission of a training sequence.

It is an object of the present invention to provide an apparatus of the kind set forth in the opening paragraph that has better spectral efficiency and increased data throughput. This is according to the present invention realized in that said apparatus is arranged to simultaneously transmit a training sequence of said first signal and a data sequence of said second signal. The invention is based on the insight that by continuing the transmission of data sequences during the training periods a better spectral efficiency and increased data throughput is achieved.

In an embodiment of the present invention said apparatus is arranged to minimize a correlation between said training sequence of said first signal and said data sequence of said second signal. This embodiment is based on the insight that simultaneous transmission of a training sequence of the first signal and the data sequence of the second signal is only possible when the training sequence and the data sequence have a low correlation. Therefore, the apparatus is arranged to minimize the correlation between the training sequence of the first signal and the data sequence of the second signal, if the data sequences and the training sequences are correlated.

In an embodiment of the present invention said apparatus is arranged to minimize said correlation by selecting said training sequence from a group of possible training sequences, said selected training sequence being arranged to have minimal correlation with said data sequence. Although there are many training sequences possible, some training sequences have a lower correlation with a data sequence than others. By choosing these optimal training sequences for transmission, the correlation between training sequence and data sequence can be minimized.

According to an embodiment of the present invention, said apparatus is arranged to minimize said correlation by interleaving said data sequence. In this embodiment the correlation between the data sequences and the training sequences is minimized by scrambling the data sequences using interleaving.

In an embodiment of the present invention said apparatus is arranged to minimize said correlation by modulating said training sequence with a first modulation and to modulate said data sequence with a second modulation. Suitable modulations could for example be BPSK, QPSK, DQPSK, x-PSK and x-QAM with x=4,8,16,32 or analogue modulations like FSK and ASK.

These and other aspects of the present invention will be elucidated by means of the following drawings.

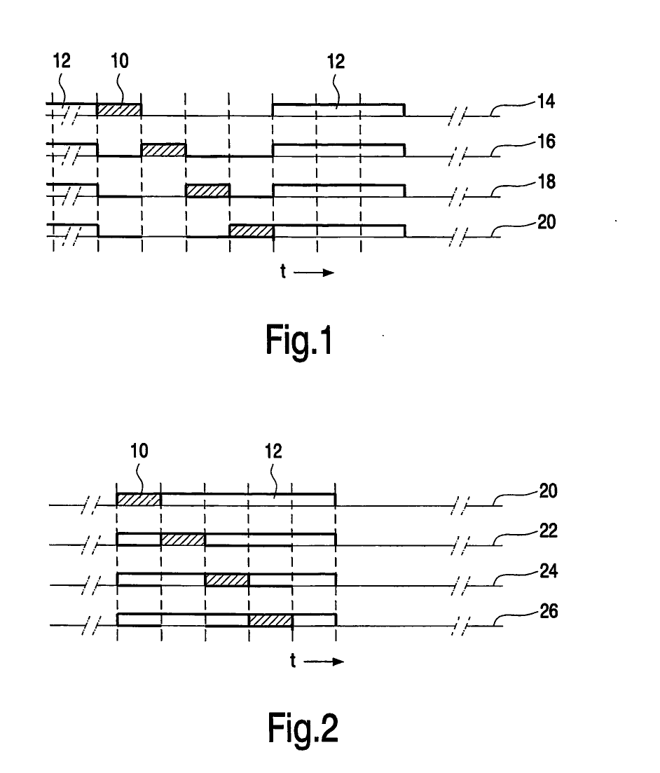

FIG. 1 shows a timing diagram of training sequences and data sequences.

FIG. 2 shows a timing diagram of training sequences and data sequences according to the present invention.

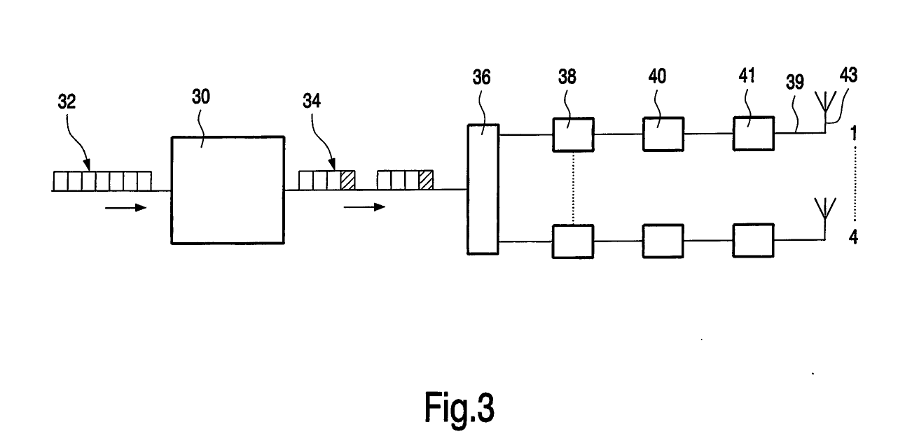

FIG. 3 shows a transmitter according to the present invention.

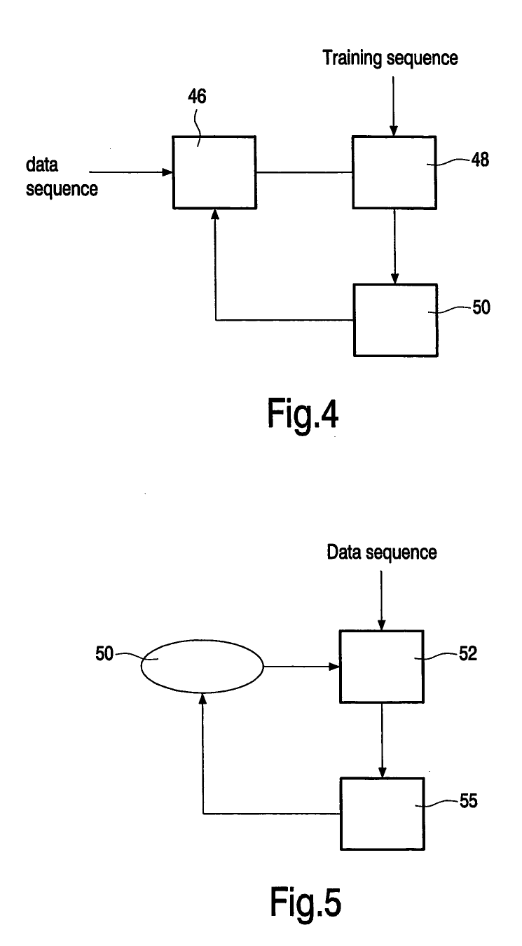

FIG. 4 shows an embodiment for minimizing the correlation.

FIG. 5 shows another embodiment for minimizing the correlation.

FIG. 1 shows a timing diagram of a training period that involves signals 14, 16, 18, 20. Each of those signals comprising a training sequence 10 and a data sequence 12. The training sequences 10 are arranged such that they do not overlap. In addition the data sequences 12 are only transmitted prior to or after the training period.

FIG. 2 shows a timing diagram according to the present invention of a training period that involves signals 20, 22, 24 and 26. Shown is, that in contrast to FIG. 1, data sequences 12 are being transmitted during the transmission of the training sequences 10. For example, if signal 20 transmits its training sequence, signals 22,24 and 26 may at the same time transmit a data sequence. The embodiment of FIG. 2 therefore offers the advantage of an improved spectral efficiency and data throughput.

FIG. 3 shows a telecommunication system according to the present invention. In FIG. 3, an input data stream 32 is forwarded to element 30 for segmentation of the data stream 32 and for the addition of a training sequence. The resulting sequences 34 are forwarded to distribution element 36 for distribution to n parallel transmitting chains 39 where they can be transmitted according to the scheme of FIG. 2. In case of e.g. an OFDM (Orthogonal Frequency Division Multiplex) system, a transmission chain 39 comprises pilot insertion 38 for insertion of pilot symbols into the data stream for tracking purposes at the receiving end, windowing 40 for adding guard periods to the OFDM sub carriers, an RF part 41 and finally, an antenna 43. If a data sequence 12 from one of the signals 20,22,24,26 and a training sequence 10 from one of the other signals 20,22,24,26 are correlated, element 30 is arranged to minimize the correlation. To this end, element 30 can be arranged to minimize correlation by choosing a different modulation for the training sequences and data sequences. Suitable modulations may for example be BPSK, QPSK, DQPSK, x-PSK and x-QAM with x=4,8,16,32 or analogue modulations like FSK or ASK. It could however be of an advantage to always modulate the training sequence using BPSK modulation since this type of modulation offers a good signal to noise ratio for reasonably short training sequences. Alternatively, element 30 could be arranged to interleave (scramble) the data sequences to minimize the correlation. Then again element 30 could be arranged to select a suitable training sequence that by design has a low correlation with the data sequences.

FIG. 4 shows an embodiment for minimizing the correlation between the data sequences 12 and the training sequences 10. Element 46 can be arranged to interleave the data sequences using a certain interleaving depth, or element 46 can be arranged to modulate the data sequences using different modulations. The correlation between a training sequence and a data sequence is calculated in element 48. Comparator 50 compares the calculated correlation with a certain threshold value. If the calculated correlation is of an acceptable level, the training sequence is added to the data sequence and is transmitted. If however, the level of correlation is not acceptable, element 46 either modulates the data sequence again using a different modulation or interleaves the data sequence using a different interleaving dept. The embodiment of FIG. 4 can be used in various ways. It is for example possible to determine an optimum modulation or an optimum interleaving dept only once and than use these optimum settings for the remainder of the transmission. It is however equally possible to repeat minimizing the correlation at regular intervals. Furthermore, in the process of stepwise minimizing the correlation, it is possible to use the same data sequence over and over until correlation is minimized but at the same time, it is also possible to use successive data sequences.

In FIG. 5, an embodiment is shown for minimizing correlation by selecting an optimal training sequence. A training sequence is selected from, for example, a database comprising several suitable training sequences 50. The selected training sequence and a data sequence are correlated in element 52. Comparator 55 determines if the level of correlation is acceptable or not. If the level of correlation is acceptable, the selected training sequence is used in the transmission. If, on the other hand, the level of correlation is not acceptable, the embodiment is arranged to select an other training sequence. The embodiment of in FIG. 5 is usable various ways. It is for example possible to determine an optimum training sequence only once and to use this training sequence for the remainder of the transmission. It is however also possible to repeat minimizing the correlation at regular intervals. In the process of Stepwise minimizing the correlation it is possible to use the same data sequence over and over until correlation is minimized. However, it is also possible to use successive data sequences.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Apparatus for simultaneous transmission of at least a first signal and a second signal, each one of said signals comprising a data sequence and a training sequence characterized in that said apparatus is arranged to simultaneously transmit a training sequence of said first signal and a data sequence of said second signal.

2. Apparatus according to claim 1, characterized in that said apparatus is arranged to minimize a correlation between said training sequence of said first signal and said data sequence of said second signal.

3. Apparatus according to claim 2, characterized in that said apparatus is being arranged to repeatedly minimize said correlation.

4. Apparatus according to claim 2, characterized in that said apparatus is arranged to minimize said correlation by selecting said training sequence from a group of possible training sequences, said selected training sequence being arranged to have minimal correlation with said data sequence.

5. Apparatus according to claim 2, characterized in that said apparatus is arranged to minimize said correlation by interleaving said data sequence.

6. Apparatus according to claim 2, characterized in that said apparatus is arranged to minimize said correlation by modulating said training sequence with a first modulation and to modulate said data sequence with a second modulation.

7. Module for use in an apparatus as claimed in claim 2 wherein said module is arranged to minimize a correlation between a training sequence of a first signal and a data sequence of a second signal.

8. Simultaneous signals for transmission by an apparatus as claimed in claim 1,
said simultaneous signals comprising at least a first signal and a second signal,
said first signal and said second signal comprising a data sequence and a training sequence wherein, a trainings sequence of said first signal and a data sequence of said second signal are arranged to be simultaneously transmitted.

9. Simultaneous signals for transmission by an apparatus as claimed in claim 2,
said simultaneous signals comprising at least a first signal and a second signal,
said first signal and said second signal comprising a data sequence and a training sequence wherein, a trainings sequence of said first signal and a data sequence of said second signal are arranged to be simultaneously transmitted.

10. Simultaneous signals for transmission by an apparatus as claimed in claim 3,
said simultaneous signals comprising at least a first signal and a second signal,
said first signal and said second signal comprising a data sequence and a training sequence wherein, a trainings sequence of said first signal and a data sequence of said second signal are arranged to be simultaneously transmitted.

11. Simultaneous signals for transmission by an apparatus as claimed in claim 4,
said simultaneous signals comprising at least a first signal and a second signal,
said first signal and said second signal comprising a data sequence and a training sequence wherein, a trainings sequence of said first signal and a data sequence of said second signal are arranged to be simultaneously transmitted.

12. Simultaneous signals for transmission by an apparatus as claimed in claim 5,
said simultaneous signals comprising at least a first signal and a second signal,
said first signal and said second signal comprising a data sequence and a training sequence wherein, a trainings sequence of said first signal and a data sequence of said second signal are arranged to be simultaneously transmitted.

13. Simultaneous signals for transmission by an apparatus as claimed in claim 6,
said simultaneous signals comprising at least a first signal and a second signal,
said first signal and said second signal comprising a data sequence and a training sequence wherein, a trainings sequence of said first signal and a data sequence of said second signal are arranged to be simultaneously transmitted.
